(19) United States
(12) Patent Application Publication
(10) Pub. No.: US 2020/0160708 A1
(43) Pub. Date: May 21, 2020

(54) METHOD AND APPARATUS FOR ADAPTIVELY MANAGING A VEHICLE

(71) Applicant: NEC CORPORATION, Tokyo (JP)

(72) Inventors: Yuki KAMIYA, Innovis (SG); Raymond LEONG, Innovis (SG)

(73) Assignee: NEC CORPORATION, Tokyo (JP)

(21) Appl. No.: 16/627,881

(22) PCT Filed: Jun. 28, 2018
(86) PCT No.: PCT/JP2018/024574

§ 371 Date: Dec. 31, 2019

(30) Foreign Application Priority Data
Jul. 3, 2017 (SG) 10201705478P

(51) Int. Cl. G08G 1/127; G08G 1/00; G06K 9/00

(52) U.S. Cl. CPC G08G 1/127; G06K 9/00778; G08G 1/205

(57) ABSTRACT

In a first aspect, a method for adaptively managing a vehicle that is administered by a transport provider is provided, the method comprises: determining, by a processor, an area relating to the vehicle at a location at which the vehicle has arrived; determining, by the processor, a number of individuals who are within the determined area; and predicting, by the processor, a time at which the vehicle departs the location in response to the determination of the number of individuals who are within the determined area.

### TECHNICAL FIELD

The present invention relates broadly, but not exclusively, to methods and apparatus for adaptively managing a vehicle.

### BACKGROUND ART

With the rapid economic development and the increasingly serious problem of traffic congestion, it is getting more challenging for transport providers, for example, bus operators to solve urban traffic congestion problems effectively. Moreover, urbanization poses a challenge for transportation service in urban area. One such example is that bus service operators are required to improve service quality, reliability and yet maintain efficiency.

A trip time for transport service includes travel time between bus stops and dwell time at every bus stop. Trip time prediction (e.g., for both travel time and dwell time) is important for bus operators so that they can avoid any risk of delays and unplanned high demand. Dwell time is a period of time within which a bus stays at a bus stop.

Conventionally, APC (Automated Passenger Counting) system or AFC (Automatic Fair Collection) system is used to predict dwell time based on the number of passengers. APC systems are electronic machines that count the number of passengers that board and disembark at every bus stop. On the other hand, AFC systems are the collection of components that automate the ticketing system of a public transportation network—an automated version of manual fare collection. An AFC system is usually the basis for integrated ticketing. Both systems are directed towards counting a number of passengers. However, more passengers do not always lead to more dwell time.

FIG. 1A shows results 100 that have been obtained by a conventional technique based on AVL (Automatic Vehicle Location), APC and dwell time data at upstream bus stops (or bus stops located before a specific bus stop). The results shown in FIG. 1A may be obtained by:

$$Td = max ( a * tup * \frac{NT}{C} * Nup , b * tdown * \frac{NT}{C} * Ndown ) \qquad ( 1 )$$

tᵤₚ,t_{down}: the time of one person getting on/down the bus
Nᵤₚ,N_{down}: the number of passengers getting on/down the bus
NT/C: the vehicle loading rate (i.e. the total number of passengers on board divided by capacity)
a,b: coefficients

FIG. 1A shows the dwell time needed for each vehicle at various bus stops. Line 102 represents the dwell time for vehicle k at Stop n and Stop n+1. Line 104 represents the dwell time for vehicle k+1 at Stop n and Stop n+1. As shown in FIG. 1A, more passengers do not always leads to more dwell time.

FIG. 1B shows a block diagram of a conventional system 150 utilizing one such conventional technique of three-dimensional automatic passenger counter (or “3D APC”). An automatic passenger counter (APC) 152 is used together with a 3D video camera system 156 to scan the body heights and contour of the passengers and perform individual counts as they are leaving or entering the bus in groups. APC 152 is also capable of telling the shape differences between the bag and the passenger, which significantly enhance the reliability of a bus automatic passenger counter. The date information would be sent to an on-board AVL processor 154 for displaying on a display 158. This data helps to predict dwell time at the successive bus stops. However, this method assumes that the longer dwell time of upstream bus stops leads the longer dwell time for the next bus stop. That is, this technique does not reflect the current situation on board the bus, thus the prediction is not accurate. Moreover, one of the problems with these techniques shown in FIGS. 1A and 1B is that they do not consider the crowd level on board of the bus.

A need therefore exists to provide methods for adaptively managing a vehicle that addresses one or more of the above problems.

Furthermore, other desirable features and characteristics will become apparent from the subsequent detailed description and the appended claims, taken in conjunction with the accompanying drawings and this background of the disclosure.

### SUMMARY OF INVENTION

### Solution to Problem

In a first aspect, a method for adaptively managing a vehicle that is administered by a transport provider is provided, the method comprises: determining, by a processor, an area relating to the vehicle at a location at which the vehicle has arrived; determining, by the processor, a number of individuals who are within the determined area; and predicting, by the processor, a time at which the vehicle departs the location in response to the determination of the number of individuals who are within the determined area.

In an embodiment, the step of determining a number of individuals comprises: receiving an input relating to the number of individuals; the input being one that is sent from at least one of an image capturing device, a pressure sensor, a temperature sensor and a motion sensor, wherein the number of individuals is determined in response to the step of receiving the input.

In an embodiment, the step of predicting the time at which the vehicle departs the location comprises: retrieving, by the processor, historical data relevant to the vehicle the historical data relating to a plurality of trips that have been done by at least one other vehicle; analyzing, by the processor, the retrieved historical data, wherein the time at which the vehicle departs the location is predicted in response to the step of analyzing the retrieved historical data.

In an embodiment, the step of analyzing the retrieved historical data comprises: retrieving, by the processor, a corresponding arrival time of the at least one vehicle at the location;

retrieving, by the processor, a corresponding departure time of the at least one vehicle at the location; and
determining, by the processor, a period of time that the at least one other vehicle has stayed at the location in response to the retrieval of the corresponding arrival time and the corresponding departure time.

In an embodiment, the step of analyzing the retrieved historical data comprises: retrieving, by the processor, historical transaction data relating to the individuals who have boarded the at least one other vehicle at the location.

In an embodiment, the step of analyzing the retrieved historical data comprises: determining, by the processor, a corresponding number of individuals who have boarded the at least one other vehicle at the location in response to the retrieval of the historical transaction data.

In an embodiment, the time at which the vehicle departs the location is predicted in response to at least one of the determination of the corresponding number of individuals who have boarded the at least one other vehicle at the location and the determination of the period of time that the at least one other vehicle has stayed at the location.

In an embodiment, the step of determining, by a processor, the determined area relating to the vehicle at a location at which the vehicle has arrived comprises identifying, by the processor, an area on the vehicle, the area relating to one in which the individuals may board or alight the vehicle.

In an embodiment, wherein the step of predicting, by the processor, the time at which the vehicle departs the location in response to the determination of the number of individuals who are within the determined area comprises determining, by the processor, a time period that the vehicle is predicted to stay at the location in response to an arrival time and the predicted time at which the vehicle departs the location; and

determining, by the processor, whether or not the time period that the vehicle is predicted to stay at the location is above a threshold time period.

In an embodiment, the method further comprises sending, by the processor, a notification when it is determined that the time period that the vehicle is predicted to stay at the location is below a threshold time period.

In a second aspect, an apparatus for adaptively managing a vehicle that is administered by a transport provider is provided, the apparatus comprising:

at least one processor; and
at least one memory including computer program code;
the at least one memory and the computer program code configured to, with at least one processor, cause the apparatus at least to:
determine an area relating to the vehicle at a location at which the vehicle has arrived;
determine a number of individuals who are within the determined area; and
predict a time at which the vehicle departs the location in response to the determination of the number of individuals who are within the determined area.

In an embodiment, the at least one memory and the computer program code is further configured with the at least one processor to:

receive an input relating to the number of individuals; the input being one that is sent from at least one of an image capturing device, a pressure sensor, a temperature sensor and a motion sensor, wherein the number of individuals is determined in response to the step of receiving the input.

In an embodiment, the at least one memory and the computer program code is further configured with the at least one processor to:

retrieve historical data relevant to the vehicle, the historical data relating to a plurality of trips that have been done by at least one other vehicle;
analyze by the processor, the retrieved historical data,

wherein the time at which the vehicle departs the location is predicted in response to the step of analyzing the retrieved historical data.

In an embodiment, the at least one memory and the computer program code is further configured with the at least one processor to:

retrieve a corresponding arrival time of the at least one vehicle at the location;
retrieve a corresponding departure time of the at least one vehicle at the location; and
determine a period of time that the at least one other vehicle has stayed at the location in response to the retrieval of the corresponding arrival time and the corresponding departure time.

In an embodiment, the at least one memory and the computer program code is further configured with the at least one processor to:

retrieve historical transaction data relating to the individuals who have boarded the at least one other vehicle at the location.

In an embodiment, the at least one memory and the computer program code is further configured with the at least one processor to:

determine a corresponding number of individuals who have boarded the at least one other vehicle at the location in response to the retrieval of the historical transaction data.

In an embodiment, the at least one memory and the computer program code is further configured with the at least one processor to:

predict the time at which the vehicle departs the location in response to at least one of the determination of the corresponding number of individuals who have boarded the at least one other vehicle at the location and the determination of the period of time that the at least one other vehicle has stayed at the location.

In an embodiment, the at least one memory and the computer program code is further configured with the at least one processor to:

identify an area on the vehicle, the area relating to one in which the individuals may board or alight the vehicle.

In an embodiment, the at least one memory and the computer program code is further configured with the at least one processor to:

determine a time period that the vehicle is predicted to stay at the location in response to an arrival time and the predicted time at which the vehicle departs the location; and

determine whether or not the time period that the vehicle is predicted to stay at the location is above a threshold time period.

In an embodiment, the at least one memory and the computer program code is further configured with the at least one processor to:

send a notification when it is determined that the time period that the vehicle is predicted to stay at the location is below a threshold time period.

### BRIEF DESCRIPTION OF DRAWINGS

Embodiments of the invention will be better understood and readily apparent to one of ordinary skill in the art from the following written description, by way of example only, and in conjunction with the drawings, in which:

FIG. 1A shows how conventional techniques are used to adaptively manage a vehicle.

FIG. 1B shows a block diagram of a conventional system utilizing one such conventional technique of three-dimensional automatic passenger counter.

FIG. 2 shows a block diagram of a system within which a vehicle is adaptively managed according to an embodiment.

FIG. 3 shows a flowchart illustrating a method for adaptively managing a vehicle in accordance with embodiments of the invention.

FIG. 4A shows an example as to how a vehicle is adaptively managed in accordance with embodiments of the present inventions.

FIG. 4B a second step of creating a dwell time prediction model with historical data on dwell time and crowd level.

FIG. 4C shows a third step of predicting a dwell time for the next location based on the model built in FIG. 4B with real-time crowd level data.

FIG. 5 shows how a dwell time prediction model may be built in accordance with embodiments of the invention.

FIG. 6 shows a table 600 that is obtained from the dwell time prediction model.

FIG. 7 shows a graph that is obtained in response to the weightage functions obtained in accordance with an embodiment of the invention.

FIG. 8 shows a comparison of the prior arts and embodiments using two examples.

FIG. 9 depicts an exemplary computing device 900, hereinafter interchangeably referred to as a computer system 900, where one or more such computing devices 900 may be used to execute the method of FIG. 3.

### DESCRIPTION OF EMBODIMENTS

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “calculating”, “determining”, “updating”, “generating”, “initializing”, “outputting”, “receiving”, “retrieving”, “identifying”, “dispersing”, “authenticating” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

Various embodiments of the present invention relate to methods and apparatuses for adaptively managing a vehicle. In an embodiment, the method and apparatus determine a number of individuals within a determined area and predict a time at which the vehicle departs the location in response to the determination of individuals who are within the determined area.

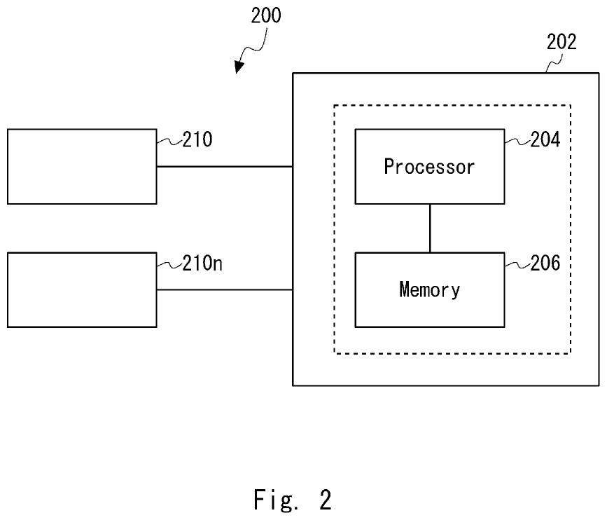

FIG. 2 shows a block diagrams of a system 200 within a vehicle is adaptively managed according to an embodiment.

Referring to FIG. 2, provision of the process involves an apparatus 202 that is operationally coupled to at least one sensor 210. Each sensor 210 is configured to detect at least one of an input concerning (i) an area relating to the vehicle at a location at which the vehicle has arrived and (ii) a number of individuals within the determined area. The sensor 210 may be, among other things, include an image capturing device, a pressure sensor, a temperature sensor and a motion sensor. The apparatus 202 is configured to receive the inputs detected by the sensor 210, directly or indirectly via a transmitter.

The sensor 210 is capable of wireless communication using a suitable protocol with the apparatus 202. For example, embodiments may be implemented using sensors 210 that are capable of communicating with WiFi/Bluetooth-enabled apparatus 202. It will be appreciated by a person skilled in the art that depending on the wireless communication protocol used, appropriate handshaking procedures may need to be carried out to establish communication between the sensor 210 and the apparatus 202. For example, in the case of Bluetooth communication, discovery and pairing of the sensor 210 and the apparatus 202 may be carried out to establish communication.

In an example, when a vehicle arrives at a location, the arrival time may be detected at a sensor 210 that is located at that location. The arrival time may be recorded in response of the vehicle arriving at the location. In other words, the arrival time relates to a beginning of a dwell time of the vehicle at the location. The sensor 210 at the location may also be configured to record a departure time at which the vehicle leaves or departs the location. The period during which the vehicle stays at the location is a dwell time. The dwell time represents a period during which the vehicle stays at a location and can be determined based on the arrival time and the departure time of the vehicle at that location.

For various embodiments in this description, the time at which the vehicle departs the location may be predicted based on a determination of an area relating to the vehicle at the location and the determination of a number of individuals who are within the determined area. The determination of the area relating to the vehicle at the location and the determination of the number of individuals who are within the determined area may be carried out in response to the inputs that the apparatus 202 receives from the sensor 210.

The apparatus 202 may include a processor 204 and a memory 206. In embodiments of the invention, the memory 206 and the computer program code, with processor 204, are configured to cause the apparatus 202 to determine an area relating to the vehicle at a location at which the vehicle has arrived; determine a number of individuals who are within the determined area; and predict a time at which the vehicle departs the location in response to the determination of the number of individuals who are within the determined area.

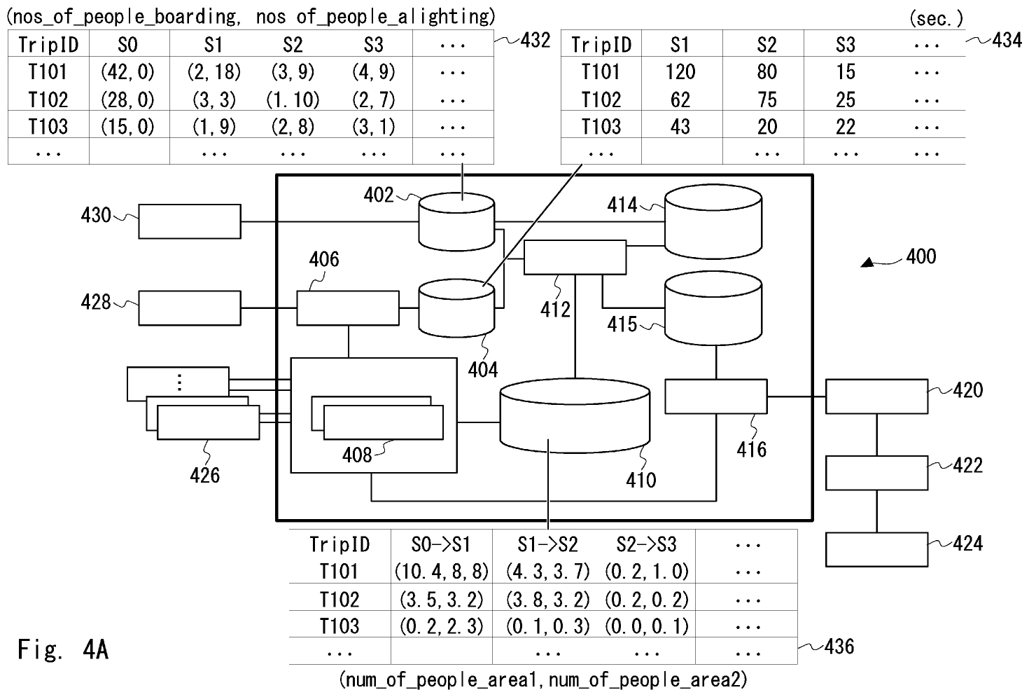

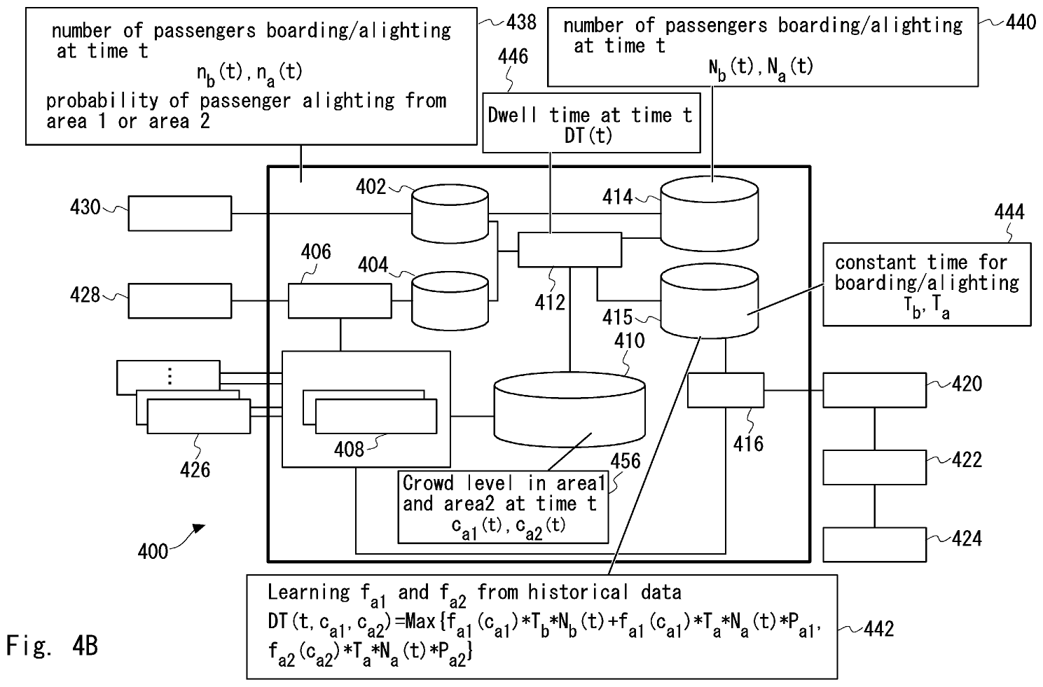

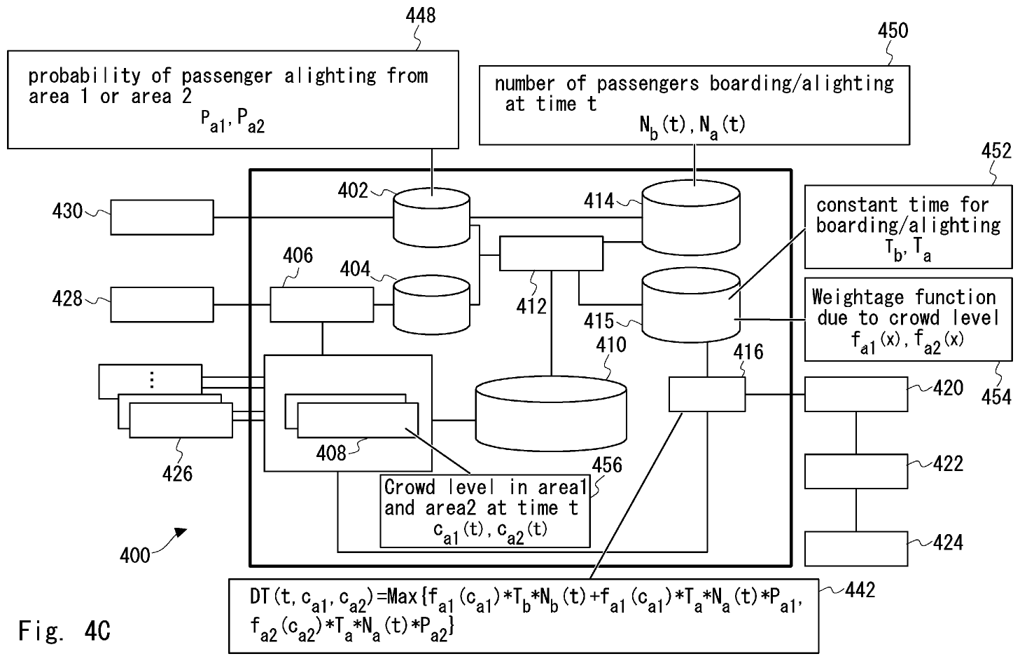

The apparatus 202 may be a server (e.g. a dwell time predicting server 416 in FIG. 4 below). In embodiments of the present invention, use of the term ‘server’ may mean a single computing device or at least a computer network of interconnected computing devices which operate together to perform a particular function. In other words, the server may be contained within a single hardware unit or be distributed among several or many different hardware units.

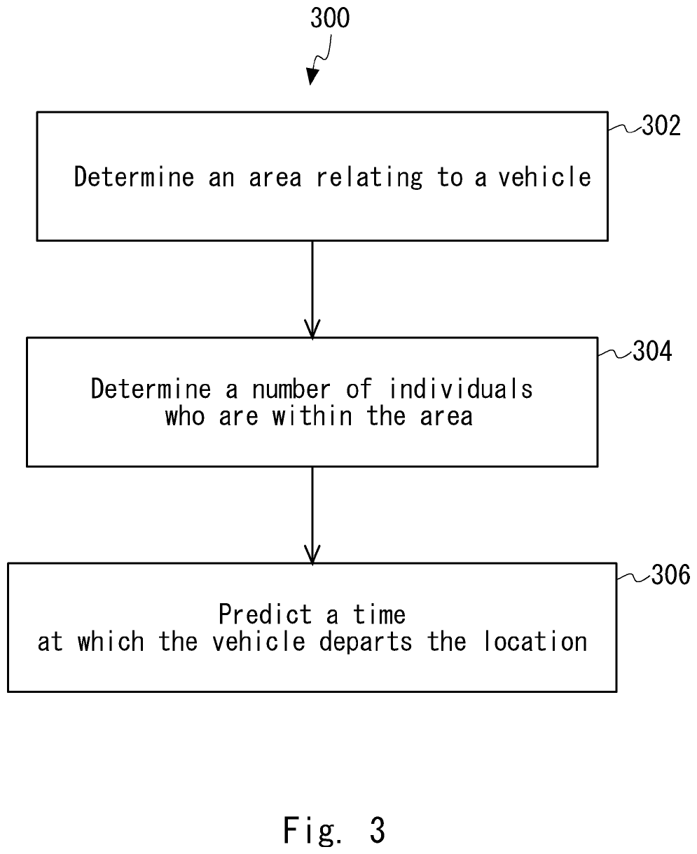

Such a server may be used to implement the method 300 shown in FIG. 3. FIG. 3 shows a flowchart illustrating a method 300 for adaptively managing of a vehicle that is administered by a transport provider in accordance with embodiments of the invention.

High frequency bus operations in metropolitan areas are expected to provide a reliable service to passengers by reducing their excess waiting time (EWTs) at bus stations. In several metropolis, such as London and Singapore, bus operators receive monetary incentives if they manage to reduce the EWTs of passengers or penalties if they fail to do so. However, optimizing the regularity of bus operations by preventing bus bunching is a computationally intractable problem and bus operators are not able to schedule the daily bus trips in an optimal way. Therefore, transport providers (or bus operators) rely on in-house expertise to manage their operations without fully exploiting the potential of applying operational control measures such as dispatching and bus holding at stations. Research has shown that “in-vehicle circulation” is one of the factors that affect dwell time. Embodiments of the present invention allow one to determine a crowd level (e.g., a number of individuals) along an aisle (e.g., a determined area) on board which is highly related to the boarding/alighting time. The time that it takes for everyone in the crowd to board or alight the vehicle affects the dwell time of the vehicle.

Thus, embodiments of the present invention can advantageously adaptively manage a vehicle that is administered by a transport provider by predicting a time at which the vehicle is expected to leave the location based on a crowd level in a determined area that is highly related to the boarding/alighting time. In an event that the vehicle is predicted to depart the location a later time that expected, a notification will be sent the transport provider, allowing the transport provider to adaptively manage the entire operation (e.g, dispatch a vehicle earlier than expected) in view of the predicted delay. This is made possible because various embodiments determine a more accurate dwell time of the vehicle at a location based on a crowd level in a determined area that is highly related to the boarding/alighting time. In stark contrast, conventional techniques only consider a number of passengers boarding/alighting the vehicle.

The method 300 broadly includes:

step 302: determining, by a processor, an area relating to the vehicle at a location at which the vehicle has arrived.

step 304: determining, by the processor, a number of individuals who are within the determined area.

step 306: predicting, by the processor, a time at which the vehicle departs the location in response to the determination of the number of individuals who are within the determined area.

At step 302, the method 300 for adaptively managing a vehicle that is administered by a transport provider includes identifying an area on the vehicle. The area being one in which individuals (e.g., passengers) may board or alight the vehicle. Examples of the area include, among other things, an aisle in the vehicle (e.g, a bus). In other, the area is one that is related to the in-vehicle circulation. Additionally or alternatively, the area may be one that is located at the location at which the vehicle has arrived. For example, the area may be a defined area at the location in which individuals may queue to board the vehicle. Examples of such areas include among other things, one at a bus stop that is designated for passengers who want to board a specific bus. In an example, at step 302, an image capturing device may be used to determine the area that relates to the vehicle.

At step 304, for the purposes of determining a number of individuals who are within the determined area, an input relating to the number of individuals may be received. The input being one that is sent from at least one of an image capturing device, a pressure sensor, a temperature sensor and a motion sensor. For example, a corresponding sensor may be arranged at a door of the vehicle to scan the determined area to detect motion of individuals in that determined area so as to perform a count of individuals. Additionally or alternatively, a corresponding pressure sensor may be placed on seats in the determined area so as to detect a presence of individuals when they sit on these seats, so as to perform a count of individuals.

At step 306, the step of predicting the time at which the vehicle departs the location comprises retrieving historical data relevant to the vehicle. The historical data relates to a plurality of trips that have been done by at least one other vehicle. In the following description, the vehicle that is being adaptively managed in various steps of the embodiments is referred to as “the vehicle”, which is meant to be differentiated from “the at least one other vehicle” which refers to one that has completed a similar or the same route that is scheduled for the vehicle.

Examples of the historical data include, among other things, historical transaction data and historical dwell time. The at least one vehicle is one which has finished a route that is similar to the one that the vehicle is scheduled. At step 306, the retrieved historical data is analyzed. Additionally or alternatively, the time at which the vehicle departs the location is predicted in response to the step of analyzing the retrieved historical data.

At step 306, the method comprises retrieving a corresponding arrival time of the at least one vehicle at the location. That is, the method includes retrieving, from the historical data, an arrival time at which the at least one vehicle arrived at the location. Similarly, the method comprises retrieving a corresponding departure time of the at least one vehicle at the location. That is, the method includes retrieving, from the historical data, an arrival time at which the at least one vehicle arrived at the location. That is, the method includes retrieving, from the historical data, a departure time at which the at least one vehicle arrived at the location. Additionally, the method includes analyzing the historical data to determine a period of time that the at least one other vehicle has stayed at the location in response to the retrieval of the corresponding arrival time and the corresponding departure time of the at least one vehicle at the location. In other words, the historical dwell time is one during which the at least one vehicle has spent at the location can be determined based on the corresponding retrieved arrival time and the corresponding departure time at the location. Additionally, the method includes determining a corresponding number of individuals who have boarded or alighted from the at least one other vehicle at the location. To determine the corresponding number of individuals who have boarded or alighted from the at least one other vehicle at the location, the corresponding inputs, e.g., from a pressure sensor, a temperature sensor, may be retrieved. Alternatively, historical transaction data relating to the at least one vehicle is retrieved. The historical transaction data relates to fares that have been paid by individuals for taking the ride on the vehicle. As such, the retrieved historical transaction data may be used to determine a corresponding number of individuals who have boarded the at least one other vehicle at the location.

At step 306, the time at which the vehicle departs the location may be determined based on the steps taken at step 306. That is, the method does the prediction in response to the learning data at step 306. In an embodiment, at step 306, the method first predicts a time at which the vehicle departs from the location in response to the determination of the individuals in the determined area. For example, if it is determined that there are 10 individuals in an area of 0.5 square meter, and it took the at least one other vehicle, which has taken a similar route, 120 seconds at the location. At step 306, the method may determine a time period during which the vehicle is predicted to stay at the location in response to the historical data. Additionally or alternatively, the method may first receive an input indicating an arrival time of the vehicle and determine a time period during which the vehicle may stay at the location in response to the predicted departure time.

Additionally, at step 306, the method may further comprise determining whether or not the time period that the vehicle is predicted to stay at the location is above a threshold time period. That is, the method may further determine if the vehicle is going to spend a longer time than expected, e.g., a longer dwell time, at that particular location. In the event that it is determined that the vehicle is going to have a longer dwell time than expected, a notification may be sent to the transport provider. Advantageously, this will help the transport provider to adaptively manage the efficiency of its fleet of vehicles. For example, if it is predicted that the vehicle is going to take a longer dwell time at the location, the transport provider may adjusted arrival times or departure times of the other vehicles which are scheduled to take the same route so as to better manage the demand and to reduce excess waiting time at the other locations.

FIGS. 4A-4C show an example as to how a vehicle is adaptively managed in accordance with embodiments of the present invention. FIG. 4A shows a first step of detecting dwell time of a vehicle at a location. The system 400 includes a dwell time predicting server 416 which is operationally coupled to a passenger boarding/alighting model 414 and a dwell time prediction model creating server 412 via a dwell time prediction model 415 for adaptively managing a vehicle.

The dwell time predicting server 416 typically is associated with a transport provider or a party who is optimizing efficiency of a target transport provider. A transport provider may be an entity (e.g. a company or organization) which administers (e.g. manages) a vehicle (e.g. a bus). As stated in the above, the dwell time predicting server 416 may include one or more computing devices that are used to establish communication with another server by exchanging messages with and/or passing information to another device (e.g, a sensor).

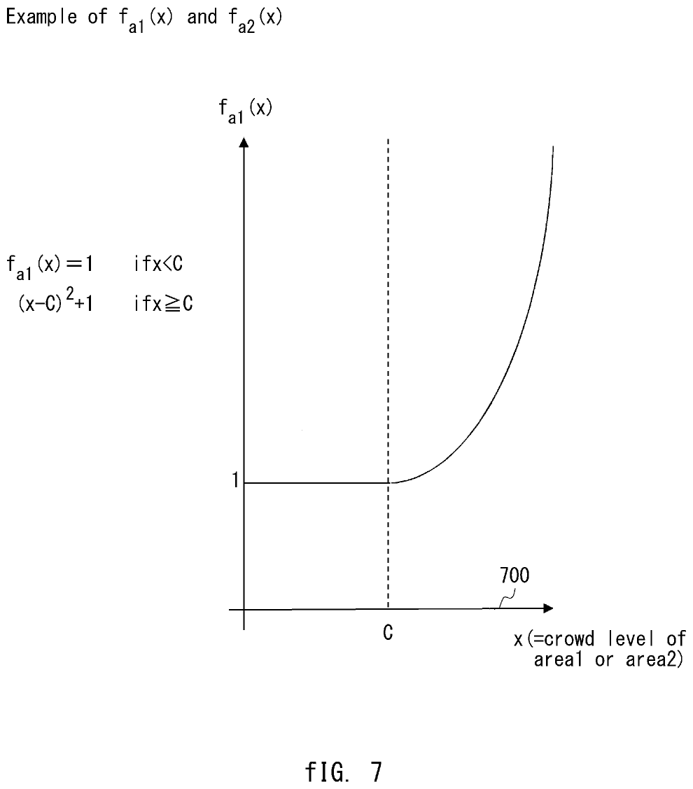

The dwell time predicting server 416 may be configured to retrieve information from a dwell time prediction model 415. The dwell time prediction model 415 receives inputs from the dwell time prediction model creating server 412. In an embodiment, the dwell time predicting server 416 is configured to retrieve inputs from the dwell time prediction model 415 for outputting an output that is directed towards predicting a dwell time. In other words, the dwell time prediction model 415 is directed towards an output that is generated in response to the receipt of the historical data and models (e.g., 402, 404, 410 and 412) as inputs at the dwell time prediction model creating server 412. More details will be provided in FIG. 7. The output may be a predicted time at which the vehicle leaves the location. The output may be used to determine if it falls within an expectation 420. That is, the output may be processed to determine if the vehicle is well on schedule. In the event that it is determined that the output is not within the expectation 420, it may be further processed to determine if it is above a threshold value. In other words, the output is further processed to determine if the dwell time is longer than expected via a long dwell time detection 422. In the event that it is determined that the dwell time is longer than expected at 422, a notification 424 may be generated.

The dwell time prediction model creating server 412 is one that is configured to output a model for predicting individuals who may board or alight a vehicle, in response to receiving historical transaction data from the corresponding database 402, the historical time data from the corresponding database 404 and information relating to crowd level in each area from the corresponding database 410. Examples of historical data included in the database 410 are shown in table 436, which indicates a number of individuals (or people) at each area at each location (e.g., bus stop).

The historical transaction data from the corresponding database 402 may be obtained via an AFC system 430 and may be sent to the passenger boarding/alighting model 414. The historical time data from the corresponding database 404 may be obtained by inputs obtained by dwell detection 406 at a location. Examples of historical data included in the database 404 are shown in table 434, which indicates dwell time of each trip at each location (e.g., bus stop). At the dwell detection 406, the inputs may be obtained via telematics 428 which is an interdisciplinary field that encompasses telecommunications, vehicular technologies, road transportation, road safety, electrical engineering (sensors, instrumentation, wireless communications, etc.), and computer science (multimedia, Internet, etc.). Examples of historical data included in the database 402 are shown as tables 432, which indicate a number of individuals (or people) boarding and alighting at each location (e.g., bus stop).

The output from the dwell detection 406 along with other relevant data inputs 426 may be received as inputs at a crowd estimation module 408. The other relevant data inputs 426 include, among other things, peak hours, weathers holidays and data which may affect the number of individuals at a location (e.g., a bus stop). The crowd estimation module 408 is configured to estimate a number of individuals (or a crowd) as an output. The output from the crowd estimation module 408 is received as an input at the dwell time prediction model creating server 412.

FIG. 4B shows a second step of creating a dwell time prediction model with historical data on dwell time and crowd level. That is, the number of passengers boarding or alighting a bus at a specific time, t, as shown in 438 is retrieved from the corresponding database 402 and sent to the passenger boarding/alighting model 414. The time, t, is a point in time as the vehicle travels on its scheduled trip. The passenger boarding/alighting model 414 is then configured to generate an output of a number of passengers boarding/alighting at time t (e.g., Nb(t), Na(t)) which is sent to the dwell time prediction model creating server 412. Dwell time at time t is retrieved from the corresponding database 404 and crowd level in area 1 and area 2 at time t is retrieved from the corresponding database 410 respectively and both are sent to the dwell time prediction model creating server 412. At constant time, Tb, Ta, for boarding/alighting, a learning function DT(t,ca1,ca2)=Max{fa1(ca1)*Tb*Nb(t)+fa1(ca1)*Ta*Na(t)*Pa1, fa2(ca2)*Ta*Na(t)*Pa2} may be obtained in the dwell time prediction model creating server 412.

FIG. 4C shows a third step of predicting a dwell time for the next location based on the model built in FIG. 4B with real-time crowd level data. First, the relevant areas, area 1 and area 2, are determined. In an embodiment, at the crowd estimation module 408, a crowd level in area 1 and area 2 is determined at time t (e.g., ca1(t), ca2(t)). From the corresponding database 402, the probability of passengers alighting from area 1 or area 2 (e.g., Pa1 Pa2) are retrieved. Accordingly, a number of passengers boarding or alighting at time t (e.g., Nb(t), Na(t)) may be determined at the passenger boarding/alighting model 414 which is sent to the dwell time prediction model 415 as input. At the dwell time prediction model 41, a weightage function due to a crowd level (e.g., fa1(x), fa2(x)) and a constant time for boarding or alighting (e.g., Tb, Ta) will be determined which will be used for predicting a dwell time for the next location at the dwell time predicting server 416 (e.g., DT(t,ca1,ca2)=Max{fa1(ca1)*Tb*Nb(t)+fa1(ca1)*Ta*Na(t)*Pa1, fa2(ca2)*Ta*Na(t)*Pa2}).

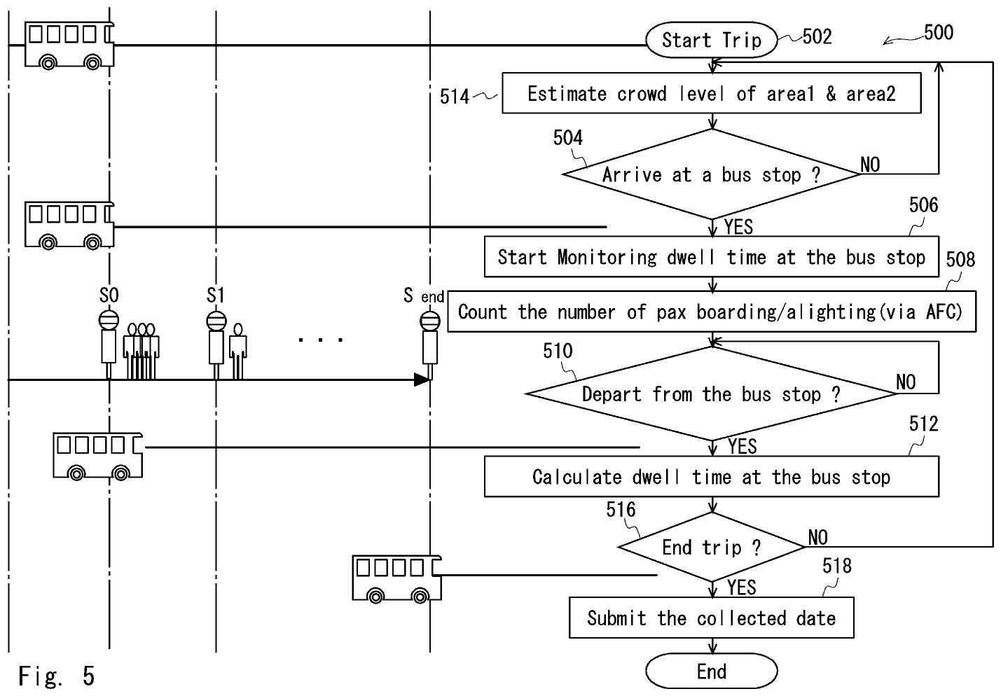

FIG. 5 shows how a dwell time prediction model may be built in accordance with embodiments of the invention. In an example, the dwell time prediction model creating server 412 is used to build the model in according with step 2 as illustrated in FIG. 4B. At step 502, a vehicle (e.g. a bus) begins its trip (e.g., T1010 as shown in table 432) as planned by the transport provider. At step 514, a number of individuals (or a crowd level) at various areas, e.g., area 1 and area 2, are estimated. At step 504, it is determined whether or not the vehicle has arrived at a bus stop (or a location). In the event that it is determined that the vehicle has arrived at a bus stop, it will start monitoring dwell time at the bus stop. The start of monitoring dwell time at the bus stop may also be a detection of an arrival time of the bus at the bus stop. At step 508, it will count the number of individuals boarding or alighting the vehicle. An AFC system may be used for this purpose at step 508. At step 510, it will determine whether or not the vehicle has departed from the bus stop. In the event that it is determined that the vehicle has departed from the bus stop, it will calculate dwell time at the bus stop at step 512. The end of monitoring dwell time at the bus stop may also be a detection of a departure time of the bus at the bus stop. At step 516, it is determined whether or not the trip has ended. Similarly, in the event that it is determined that the vehicle has not arrived at a bus stop at step 504, it will be led to step 516 to determine if the trip has ended. In the event that it is determined that the trip has ended at 516, the data is submitted at step 519. The process ends in step 520.

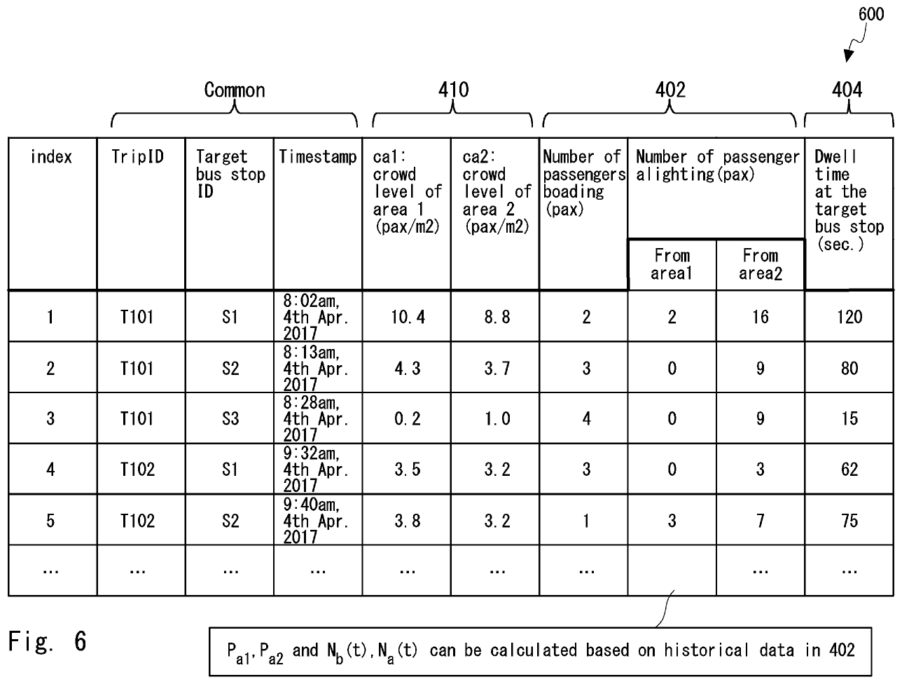

FIG. 6 shows a table 600 that is obtained from the dwell time prediction model. That is, table 600 shows training data that may be obtained from the dwell time prediction model creating server 412. As described in the above, the dwell time prediction model creating server 412 is configured to receive an input from the dwell time prediction model 415 so as to predict dwell time at a target bus stop. The input to the dwell time prediction model creating server 412 is generated in response to the receipt of the historical data and models (e.g., 402, 404, 410 and 412) at the dwell time prediction model 415. Table 600 shows that a prediction model can be created for a corresponding trip, a target bus stop or a timestamp (e.g., T101, S1, 8:02 am, 4th April 2017). As shown in table 600, a number of passengers who have boarded the bus at the previous bus stop and a number of passengers who have alighted at the previous bus stop, may be obtained from the corresponding database 402. Also, a corresponding crowd level at various areas may be obtained from the corresponding database 404. A crowd level may be a number of individuals per area. As shown in index 1 for TripID T101, a higher crowd index at area 1 (e.g., 10.4) and area 2 (8.8) will lead to a prediction of a higher dwell time (e.g., 120 seconds) at a target bus stop. The target bus stop being S1 for index 1. The target bus stop may be one that is determined by the transport provider or government to be important for determining dwell time or predicting dwell time. While FIG. 6 describes how an output, a predicted dwell time, may be generated from the dwell time prediction model creating server 412, another output, C, may also be generated from the dwell time prediction model creating server 412.

FIG. 7 shows a graph that is obtained in response to the weightage functions (fa1(x), fa2(x)), which are obtained from the dwell time prediction model 41, due to a crowd level. That is, FIG. 7 shows an example on how the dwell time prediction model creating server 412 learns using historical data. The graph shows fa1(x) against the parameter, x, where x is (crowd level of area a1/a2), where(fa1(x) represents a function of a crowd level of area 1 and (fa2(x)) represents a function of a crowd level of area 2.

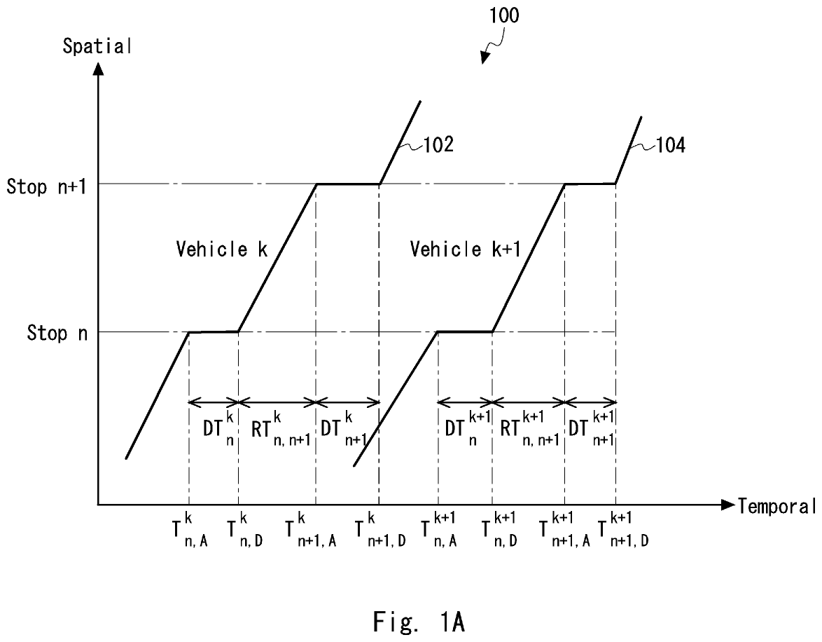

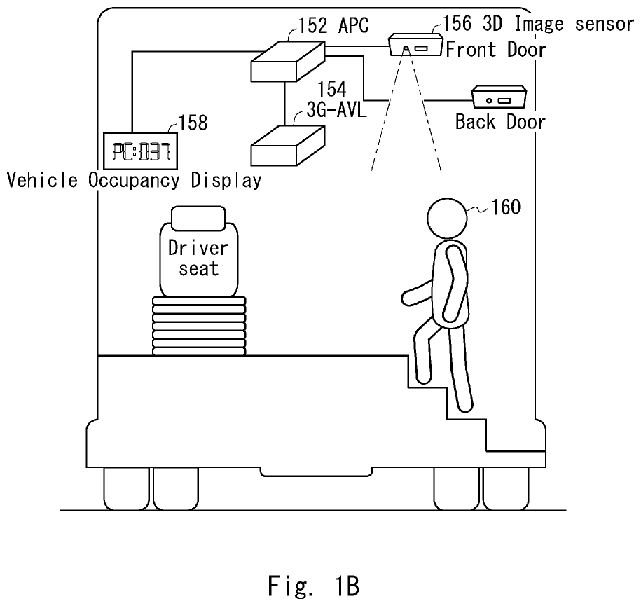

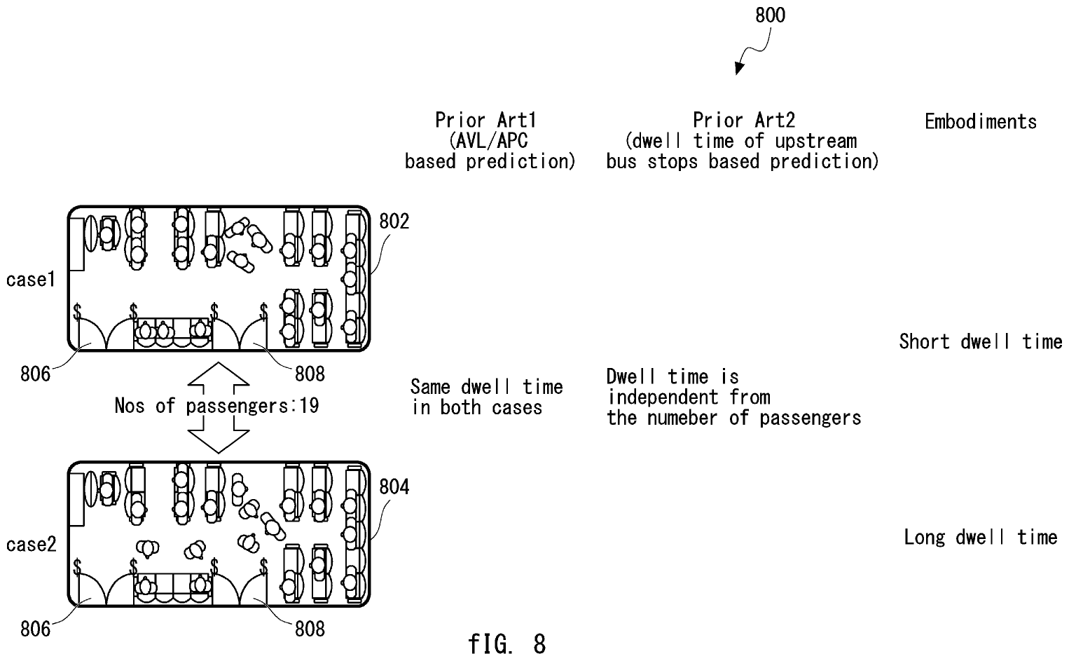

FIG. 8 shows a comparison of the prior arts and embodiments using two examples. In a first example 802 and a second example 804, the number of individuals (or passengers) on the vehicle is the same. However, in the first example 802, the number of individuals at the doors 806, 808 or area relevant to boarding/alighting is lesser than that in the second example 804. In the event that the conventional technique as shown in FIG. 1A is used, the dwell time that is obtained in the first example 802 and the second example 804 will be the same because prediction done by AVL or APC does not consider the crowd level in defined areas. If the conventional technique as shown in FIG. 1B is used, the dwell time will be based on the dwell time of previous bus stops and is independent from the number of individuals on board the vehicle. However, according to various of the embodiments, the dwell time of the first example 802 will be determined to be short since there are not as many individuals at the key areas for boarding or alighting from the vehicle. That is, the dwell time of the second example 804 will be determined to be long since there are more individuals at the key areas for boarding or alighting from the vehicle. Accordingly, it can be seen that embodiments of this inventions advantageously provide a more accurate prediction of dwell time, thereby adaptively managing a vehicle.

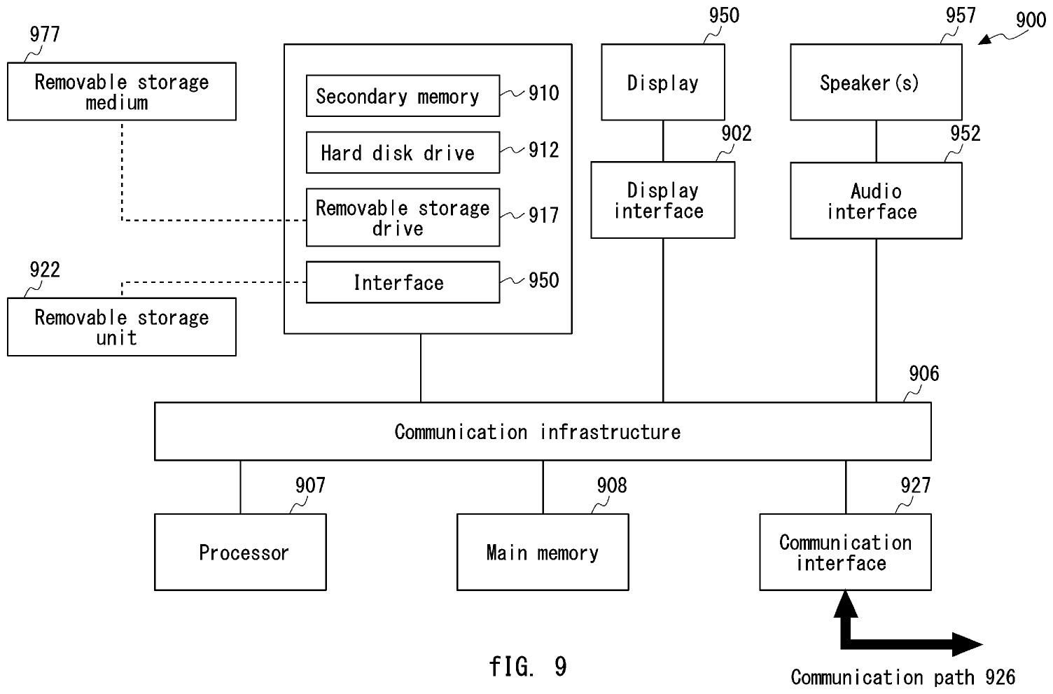

FIG. 9 depicts an exemplary computing device 900, hereinafter interchangeably referred to as a computer system 900, where one or more such computing devices 900 may be used to execute the method of FIG. 3. The exemplary computing device 900 can be used to implement the system 200, 400 shown in FIGS. 2 and 4. The following description of the computing device 900 is provided by way of example only and is not intended to be limiting.

As shown in FIG. 9, the example computing device 900 includes a processor 907 for executing software routines. Although a single processor is shown for the sake of clarity, the computing device 900 may also include a multi-processor system. The processor 907 is connected to a communication infrastructure 906 for communication with other components of the computing device 900. The communication infrastructure 906 may include, for example, a communications bus, cross-bar, or network.

The computing device 900 further includes a main memory 908, such as a random access memory (RAM), and a secondary memory 910. The secondary memory 910 may include, for example, a storage drive 912, which may be a hard disk drive, a solid state drive or a hybrid drive and/or a removable storage drive 917, which may include a magnetic tape drive, an optical disk drive, a solid state storage drive (such as a USB flash drive, a flash memory device, a solid state drive or a memory card), or the like. The removable storage drive 917 reads from and/or writes to a removable storage medium 977 in a well-known manner. The removable storage medium 977 may include magnetic tape, optical disk, non-volatile memory storage medium, or the like, which is read by and written to by removable storage drive 917. As will be appreciated by persons skilled in the relevant art(s), the removable storage medium 977 includes a computer readable storage medium having stored therein computer executable program code instructions and/or data.

In an alternative implementation, the secondary memory 910 may additionally or alternatively include other similar means for allowing computer programs or other instructions to be loaded into the computing device 900. Such means can include, for example, a removable storage unit 922 and an interface 950. Examples of a removable storage unit 922 and interface 950 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 922 and interfaces 950 which allow software and data to be transferred from the removable storage unit 922 to the computer system 900.

The computing device 900 also includes at least one communication interface 927. The communication interface 927 allows software and data to be transferred between computing device 900 and external devices via a communication path 927. In various embodiments of the inventions, the communication interface 927 permits data to be transferred between the computing device 900 and a data communication network, such as a public data or private data communication network. The communication interface 927 may be used to exchange data between different computing devices 900 which such computing devices 900 form part an interconnected computer network. Examples of a communication interface 927 can include a modem, a network interface (such as an Ethernet card), a communication port (such as a serial, parallel, printer, GPIB, IEEE 1394, RJ45, USB), an antenna with associated circuitry and the like. The communication interface 927 may be wired or may be wireless. Software and data transferred via the communication interface 927 are in the form of signals which can be electronic, electromagnetic, optical or other signals capable of being received by communication interface 927. These signals are provided to the communication interface via the communication path 927.

As shown in FIG. 9, the computing device 900 further includes a display interface 902 which performs operations for rendering images to an associated display 950 and an audio interface 952 for performing operations for playing audio content via associated speaker(s) 957.

As used herein, the term “computer program product” may refer, in part, to removable storage medium 977, removable storage unit 922, a hard disk installed in storage drive 912, or a carrier wave carrying software over communication path 927 (wireless link or cable) to communication interface 927. Computer readable storage media refers to any non-transitory, non-volatile tangible storage medium that provides recorded instructions and/or data to the computing device 900 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 900. Examples of transitory or non-tangible computer readable transmission media that may also participate in the provision of software, application programs, instructions and/or data to the computing device 900 include radio or infra-red transmission channels as well as a network connection to another computer or networked device, and the Internet or Intranets including e-mail transmissions and information recorded on Websites and the like.

The computer programs (also called computer program code) are stored in main memory 608 and/or secondary memory 910. Computer programs can also be received via the communication interface 927. Such computer programs, when executed, enable the computing device 900 to perform one or more features of embodiments discussed herein. In various embodiments, the computer programs, when executed, enable the processor 907 to perform features of the above-described embodiments. Accordingly, such computer programs represent controllers of the computer system 900.

Software may be stored in a computer program product and loaded into the computing device 900 using the removable storage drive 917, the storage drive 912, or the interface 950. The computer program product may be a non-transitory computer readable medium. Alternatively, the computer program product may be downloaded to the computer system 900 over the communications path 927. The software, when executed by the processor 907, causes the computing device 900 to perform the necessary operations to execute the method 300 as shown in FIG. 3.

It is to be understood that the embodiment of FIG. 9 is presented merely by way of example to explain the operation and structure of the system 200 or 400. Therefore, in some embodiments one or more features of the computing device 900 may be omitted. Also, in some embodiments, one or more features of the computing device 900 may be combined together. Additionally, in some embodiments, one or more features of the computing device 900 may be split into one or more component parts.

It will be appreciated that the elements illustrated in FIG. 9 function to provide means for performing the various functions and operations of the servers as described in the above embodiments.

When the computing device 900 is configured to optimize efficiency of a transport provider, the computing system 900 will have a non-transitory computer readable medium having stored thereon an application which when executed causes the computing system 900 to perform steps comprising: determine an area relating to the vehicle at a location at which the vehicle has arrived; determine a number of individuals who are within the determined area; and predict a time at which the vehicle departs the location in response to the determination of the number of individuals who are within the determined area.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

For example, the whole or part of the exemplary embodiments disclosed above can be described as, but not limited to, the following supplementary notes.

### Supplementary Note 1

A method for adaptively managing a vehicle that is administered by a transport provider, comprising:

determining, by a processor, an area relating to the vehicle at a location at which the vehicle has arrived;
determining, by the processor, a number of individuals who are within the determined area; and
predicting, by the processor, a time at which the vehicle departs the location in response to the determination of the number of individuals who are within the determined area.

### Supplementary Note 2

The method according to note 1, wherein the step of determining a number of individuals comprises:

receiving an input relating to the number of individuals; the input being one that is sent from at least one of an image capturing device, a pressure sensor, a temperature sensor and a motion sensor, wherein the number of individuals is determined in response to the step of receiving the input.

### Supplementary Note 3

The method according to note 1 or note 2, wherein the step of predicting the time at which the vehicle departs the location comprises:

retrieving, by the processor, historical data relevant to the vehicle, the historical data relating to a plurality of trips that have been done by at least one other vehicle;

analyzing, by the processor, the retrieved historical data,

wherein the time at which the vehicle departs the location is predicted in response to the step of analyzing the retrieved historical data.

### Supplementary Note 4

The method according to note 3, wherein the step of analyzing the retrieved historical data comprises:

retrieving, by the processor, a corresponding arrival time of the at least one vehicle at the location;
retrieving, by the processor, a corresponding departure time of the at least one vehicle at the location; and
determining, by the processor, a period of time that the at least one other vehicle has stayed at the location in response to the retrieval of the corresponding arrival time and the corresponding departure time.

### Supplementary Note 5

The method according to note 4, wherein the step of analyzing the retrieved historical data comprises:

retrieving, by the processor, historical transaction data relating to the individuals who have boarded the at least one other vehicle at the location.

### Supplementary Note 6

The method according to note 5, wherein the step of analyzing the retrieved historical data comprises:

determining, by the processor, a corresponding number of individuals who have boarded the at least one other vehicle at the location in response to the retrieval of the historical transaction data.

### Supplementary Note 7

The method according to note 6, wherein the time at which the vehicle departs the location is predicted in response to at least one of the determination of the corresponding number of individuals who have boarded the at least one other vehicle at the location and the determination of the period of time that the at least one other vehicle has stayed at the location.

### Supplementary Note 8

The method according to any one of the preceding notes, wherein the step of determining, by a processor, the determined area relating to the vehicle at a location at which the vehicle has arrived comprises:

identifying, by the processor, an area on the vehicle, the area relating to one in which the individuals may board or alight the vehicle.

### Supplementary Note 9

The method according to any one of the preceding notes, wherein the step of predicting, by the processor, the time at which the vehicle departs the location in response to the determination of the number of individuals who are within the determined area comprises:

determining, by the processor, a time period that the vehicle is predicted to stay at the location in response to an arrival time and the predicted time at which the vehicle departs the location; and
determining, by the processor, whether or not the time period that the vehicle is predicted to stay at the location is above a threshold time period.

### Supplementary Note 10

The method according to note 9, further comprising:

sending, by the processor, a notification when it is determined that the time period that the vehicle is predicted to stay at the location is below a threshold time period.

### Supplementary Note 11

An apparatus for adaptively managing a vehicle that is administered by a transport provider, the apparatus comprising:

at least one processor; and
at least one memory including computer program code;
the at least one memory and the computer program code configured to, with at least one processor, cause the apparatus at least to:
determine an area relating to the vehicle at a location at which the vehicle has arrived;
determine a number of individuals who are within the determined area; and
predict a time at which the vehicle departs the location in response to the determination of the number of individuals who are within the determined area.

### Supplementary Note 12

The apparatus according to note 11, wherein the at least one memory and the computer program code is further configured with the at least one processor to:

receive an input relating to the number of individuals; the input being one that is sent from at least one of an image capturing device, a pressure sensor, a temperature sensor and a motion sensor, wherein the number of individuals is determined in response to the step of receiving the input.

### Supplementary Note 13

The apparatus according to note 12, wherein the at least one memory and the computer program code is further configured with the at least one processor to:

retrieve historical data relevant to the vehicle, the historical data relating to a plurality of trips that have been done by at least one other vehicle;
analyze by the processor, the retrieved historical data,
wherein the time at which the vehicle departs the location is predicted in response to the step of analyzing the retrieved historical data.

### Supplementary Note 14

The apparatus according to note 13, wherein the at least one memory and the computer program code is further configured with the at least one processor to:

retrieve a corresponding arrival time of the at least one vehicle at the location;
retrieve a corresponding departure time of the at least one vehicle at the location; and
determine a period of time that the at least one other vehicle has stayed at the location in response to the retrieval of the corresponding arrival time and the corresponding departure time.

### Supplementary Note 15

The apparatus according to note 14, wherein the at least one memory and the computer program code is further configured with the at least one processor to:

retrieve historical transaction data relating to the individuals who have boarded the at least one other vehicle at the location.

### Supplementary Note 16

The apparatus according to note 15, wherein the at least one memory and the computer program code is further configured with the at least one processor to:

determine a corresponding number of individuals who have boarded the at least one other vehicle at the location in response to the retrieval of the historical transaction data.

### Supplementary Note 17

The apparatus according to note 16, wherein the at least one memory and the computer program code is further configured with the at least one processor to:

predict the time at which the vehicle departs the location in response to at least one of the determination of the corresponding number of individuals who have boarded the at least one other vehicle at the location and the determination of the period of time that the at least one other vehicle has stayed at the location.

### Supplementary Note 18

The apparatus according to any one of notes 11-17, wherein the at least one memory and the computer program code is further configured with the at least one processor to:

identify an area on the vehicle, the area relating to one in which the individuals may board or alight the vehicle.

### Supplementary Note 19

The apparatus according to any one of notes 11-18, wherein the at least one memory and the computer program code is further configured with the at least one processor to:

determine a time period that the vehicle is predicted to stay at the location in response to an arrival time and the predicted time at which the vehicle departs the location; and
determine whether or not the time period that the vehicle is predicted to stay at the location is above a threshold time period.

### Supplementary Note 20

The apparatus according to note 19, wherein the at least one memory and the computer program code is further configured with the at least one processor to:

send a notification when it is determined that the time period that the vehicle is predicted to stay at the location is below a threshold time period.

This application is based upon and claims the benefit of priority from Singapore patent application No. 10201705478P, filed on Jul. 3, 2017, the disclosure of which is incorporated herein in its entirety by reference.

### REFERENCE SIGNS LIST

202 apparatus

204 processor

206 memory

210 sensor

402,404, 410,414 database

406 dwell detection

408 crowd estimation module

412 dwell time prediction model creating server

415 dwell time prediction model

416 dwell time predicting server

420 expectation

422 long dwell time detection

424 notification

426 data inputs

428 telematics

430 AFC system

1. A method for adaptively managing a vehicle that is administered by a transport provider, comprising:
determining, by a processor, an area relating to the vehicle at a location at which the vehicle has arrived;
determining, by the processor, a number of individuals who are within the determined area; and
predicting, by the processor, a time at which the vehicle departs the location in response to the determination of the number of individuals who are within the determined area.

2. The method according to claim 1, wherein the step of determining a number of individuals comprises:
receiving an input relating to the number of individuals; the input being one that is sent from at least one of an image capturing device, a pressure sensor, a temperature sensor and a motion sensor, wherein the number of individuals is determined in response to the step of receiving the input.

3. The method according to claim 1, wherein the step of predicting the time at which the vehicle departs the location comprises:
retrieving, by the processor, historical data relevant to the vehicle, the historical data relating to a plurality of trips that have been done by at least one other vehicle;
analyzing, by the processor, the retrieved historical data,
wherein the time at which the vehicle departs the location is predicted in response to the step of analyzing the retrieved historical data.

4. The method according to claim 3, wherein the step of analyzing the retrieved historical data comprises:
retrieving, by the processor, a corresponding arrival time of the at least one vehicle at the location;
retrieving, by the processor, a corresponding departure time of the at least one vehicle at the location; and
determining, by the processor, a period of time that the at least one other vehicle has stayed at the location in response to the retrieval of the corresponding arrival time and the corresponding departure time.

5. The method according to claim 4, wherein the step of analyzing the retrieved historical data comprises:
retrieving, by the processor, historical transaction data relating to the individuals who have boarded the at least one other vehicle at the location.

6. The method according to claim 5, wherein the step of analyzing the retrieved historical data comprises:
determining, by the processor, a corresponding number of individuals who have boarded the at least one other vehicle at the location in response to the retrieval of the historical transaction data.

7. The method according to claim 6, wherein the time at which the vehicle departs the location is predicted in response to at least one of the determination of the corresponding number of individuals who have boarded the at least one other vehicle at the location and the determination of the period of time that the at least one other vehicle has stayed at the location.

8. The method according to claim 1, wherein the step of determining, by a processor, the determined area relating to the vehicle at a location at which the vehicle has arrived comprises:
identifying, by the processor, an area on the vehicle, the area relating to one in which the individuals may board or alight the vehicle.

9. The method according to claim 1, wherein the step of predicting, by the processor, the time at which the vehicle departs the location in response to the determination of the number of individuals who are within the determined area comprises:
determining, by the processor, a time period that the vehicle is predicted to stay at the location in response to an arrival time and the predicted time at which the vehicle departs the location; and
determining, by the processor, whether or not the time period that the vehicle is predicted to stay at the location is above a threshold time period.

10. The method according to claim 9, further comprising:
sending, by the processor, a notification when it is determined that the time period that the vehicle is predicted to stay at the location is below a threshold time period.

11. An apparatus for adaptively managing a vehicle that is administered by a transport provider, the apparatus comprising:
at least one processor; and
at least one memory including computer program code;
the at least one memory and the computer program code configured to, with at least one processor, cause the apparatus at least to:
determine an area relating to the vehicle at a location at which the vehicle has arrived;
determine a number of individuals who are within the determined area; and
predict a time at which the vehicle departs the location in response to the determination of the number of individuals who are within the determined area.

12. The apparatus according to claim 11, wherein the at least one memory and the computer program code is further configured with the at least one processor to:
receive an input relating to the number of individuals; the input being one that is sent from at least one of an image capturing device, a pressure sensor, a temperature sensor and a motion sensor, wherein the number of individuals is determined in response to the step of receiving the input.

13. The apparatus according to claim 12, wherein the at least one memory and the computer program code is further configured with the at least one processor to:
retrieve historical data relevant to the vehicle, the historical data relating to a plurality of trips that have been done by at least one other vehicle;
analyze by the processor, the retrieved historical data,
wherein the time at which the vehicle departs the location is predicted in response to the step of analyzing the retrieved historical data.

14. The apparatus according to claim 13, wherein the at least one memory and the computer program code is further configured with the at least one processor to:
retrieve a corresponding arrival time of the at least one vehicle at the location;
retrieve a corresponding departure time of the at least one vehicle at the location; and
determine a period of time that the at least one other vehicle has stayed at the location in response to the retrieval of the corresponding arrival time and the corresponding departure time.

15. The apparatus according to claim 14, wherein the at least one memory and the computer program code is further configured with the at least one processor to:
retrieve historical transaction data relating to the individuals who have boarded the at least one other vehicle at the location.

16. The apparatus according to claim 15, wherein the at least one memory and the computer program code is further configured with the at least one processor to:
determine a corresponding number of individuals who have boarded the at least one other vehicle at the location in response to the retrieval of the historical transaction data.

17. The apparatus according to claim 16, wherein the at least one memory and the computer program code is further configured with the at least one processor to:
predict the time at which the vehicle departs the location in response to at least one of the determination of the corresponding number of individuals who have boarded the at least one other vehicle at the location and the determination of the period of time that the at least one other vehicle has stayed at the location.

18. The apparatus according to claim 11, wherein the at least one memory and the computer program code is further configured with the at least one processor to:
identify an area on the vehicle, the area relating to one in which the individuals may board or alight the vehicle.

19. The apparatus according to claim 11, wherein the at least one memory and the computer program code is further configured with the at least one processor to:
determine a time period that the vehicle is predicted to stay at the location in response to an arrival time and the predicted time at which the vehicle departs the location; and
determine whether or not the time period that the vehicle is predicted to stay at the location is above a threshold time period.

20. The apparatus according to claim 19, wherein the at least one memory and the computer program code is further configured with the at least one processor to:
send a notification when it is determined that the time period that the vehicle is predicted to stay at the location is below a threshold time period.
